(19) United States
(12) Patent Application Publication
(10) Pub. No.: US 2009/0149136 A1
(43) Pub. Date: Jun. 11, 2009

(54) Terminal with Programmable Antenna and Methods for use Therewith

(75) Inventor: Ahmadreza Reza Rofougaran, Newport Coast, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/950,501

(22) Filed: Dec. 5, 2007

(51) Int. Cl. H04B 1/40

(52) U.S. Cl. 455/77

(57) ABSTRACT

A terminal device includes a transceiver. A programmable antenna is adjustable in response to a control signal and a frequency selection signal to a selected antenna parameter and a selected frequency parameter.

### BACKGROUND OF THE INVENTION

1. Technical Field of the Invention

This invention relates generally to wireless communications systems and more particularly to radio transceivers and antenna systems used within such wireless communication systems.

2. Description of Related Art

Communication systems are known to support wireless and wire line communications between wireless and/or wire line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna and includes a low noise amplifier, one or more intermediate frequency stages, a filtering stage, and a data recovery stage. The low noise amplifier (LNA) receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

Many wireless communication systems include receivers and transmitters that can operate over a range of possible carrier frequencies. Antennas are typically chosen to likewise operate over the range of possible frequencies, obtaining greater bandwidth at the expense of lower gain. Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention.

FIG. 2 is a schematic block diagram of a radio frequency identification system in accordance with the present invention.

FIG. 3 is a schematic block diagram of an RF transceiver in accordance with the present invention.

FIG. 4 is a schematic block diagram of an embodiment of a programmable antenna in accordance with the present invention.

FIG. 5 is a schematic block diagram of an embodiment of a programmable antenna element in accordance with the present invention.

FIG. 6 is a schematic block diagram of an embodiment of an adjustable impedance in accordance with the present invention.

FIG. 7 is a schematic block diagram of an embodiment of an adjustable impedance in accordance with the present invention.

FIG. 8 is a schematic block diagram of an embodiment of an adjustable impedance in accordance with the present invention.

FIG. 9 is a schematic block diagram of an embodiment of an adjustable impedance in accordance with the present invention.

FIG. 10 is a schematic block diagram of an embodiment of an adjustable impedance in accordance with the present invention.

FIG. 11 is a schematic block diagram of an embodiment of a programmable impedance matching network in accordance with the present invention.

FIG. 12 is a schematic block diagram of an embodiment of a programmable impedance matching network in accordance with the present invention.

FIG. 13 is a schematic block diagram of an embodiment of an adjustable transformer in accordance with the present invention.

FIG. 14 is a schematic block diagram of an RF transmission system in accordance with the present invention.

FIG. 15 is a schematic block diagram of an RF reception system in accordance with the present invention.

FIG. 16 is a flowchart representation of a method in accordance with an embodiment of the present invention.

### DETAILED DESCRIPTION OF THE INVENTION

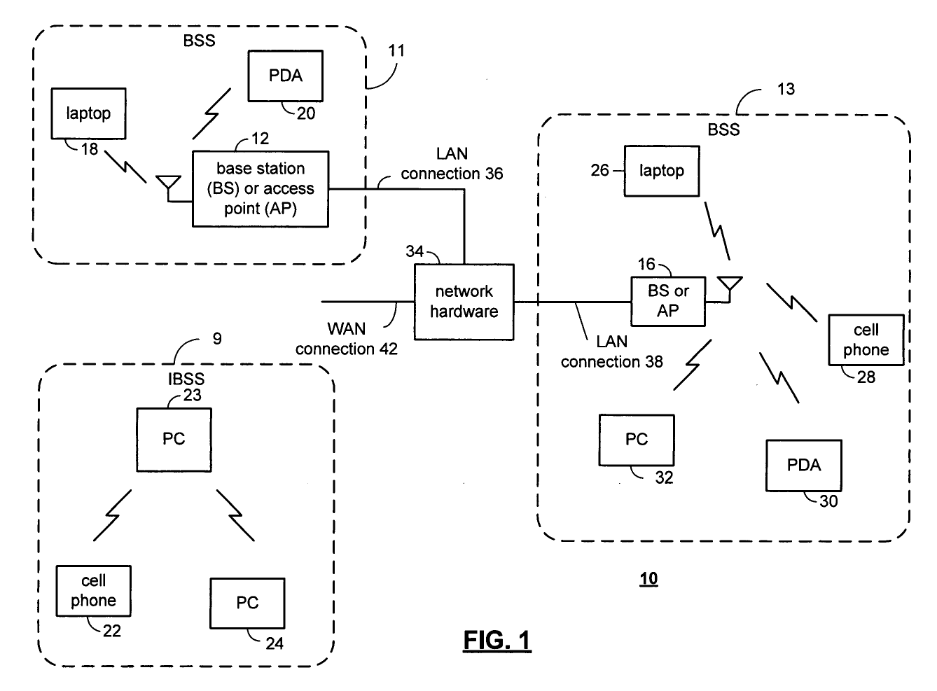

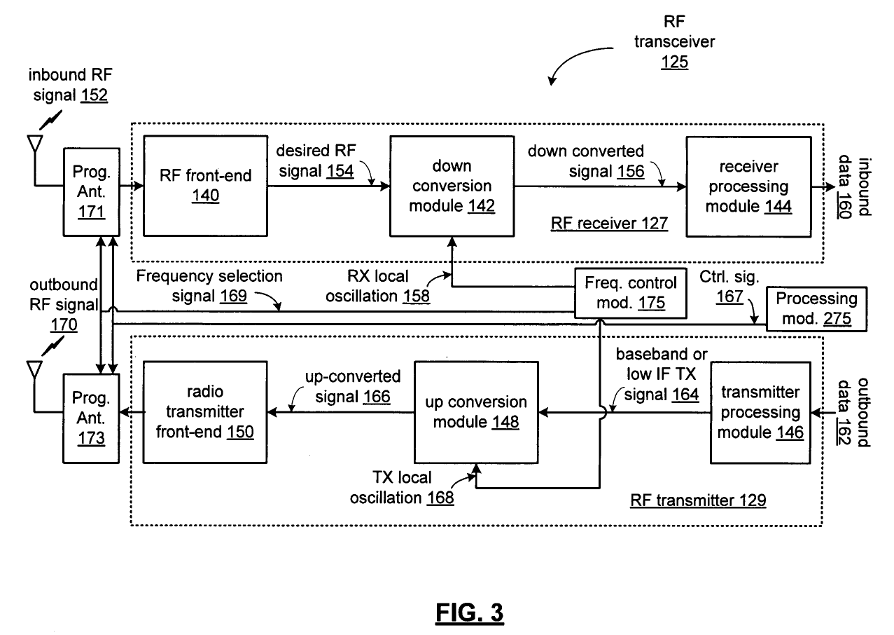

FIG. 1 is a schematic block diagram illustrating a communication system 10 that includes a plurality of base stations and/or access points 12, 16, a plurality of wireless communication devices 18-32 and a network hardware component 34. Note that the network hardware 34, which may be a router, switch, bridge, modem, system controller, et cetera provides a wide area network connection 42 for the communication system 10. Further note that the wireless communication devices 18-32 may be laptop host computers 18 and 26, personal digital assistant hosts 20 and 30, personal computer hosts 24 and 32 and/or cellular telephone hosts 22 and 28 that include a wireless transceiver. The details of the wireless transceiver will be described in greater detail with reference to FIG. 3.

Wireless communication devices 22, 23, and 24 are located within an independent basic service set (IBSS) area and communicate directly (i.e., point to point). In this configuration, these devices 22, 23, and 24 may only communicate with each other. To communicate with other wireless communication devices within the system 10 or to communicate outside of the system 10, the devices 22, 23, and/or 24 need to affiliate with one of the base stations or access points 12 or 16.

The base stations or access points 12, 16 are located within basic service set (BSS) areas 11 and 13, respectively, and are operably coupled to the network hardware 34 via local area network connections 36, 38. Such a connection provides the base station or access point 12, 16 with connectivity to other devices within the system 10 and provides connectivity to other networks via the WAN connection 42. To communicate with the wireless communication devices within its BSS 11 or 13, each of the base stations or access points 12-16 has an associated antenna or antenna array. For instance, base station or access point 12 wirelessly communicates with wireless communication devices 18 and 20 while base station or access point 16 wirelessly communicates with wireless communication devices 26-32. Typically, the wireless communication devices register with a particular base station or access point 12, 16 to receive services from the communication system 10.

Typically, base stations are used for cellular telephone systems and like-type systems, while access points are used for in-home or in-building wireless networks (e.g., IEEE 802.11 and versions thereof, Bluetooth, RFID, and/or any other type of radio frequency based network protocol). Regardless of the particular type of communication system, each wireless communication device includes a built-in radio and/or is coupled to a radio. Note that one or more of the wireless communication devices may include an RFID reader and/or an RFID tag.

In accordance with an embodiment of the present invention, base station or access points 12, 16 and communication devices 22, 23 and/or 24 include a programmable antenna as will described in conjunction with FIGS. 3-16 that follow.

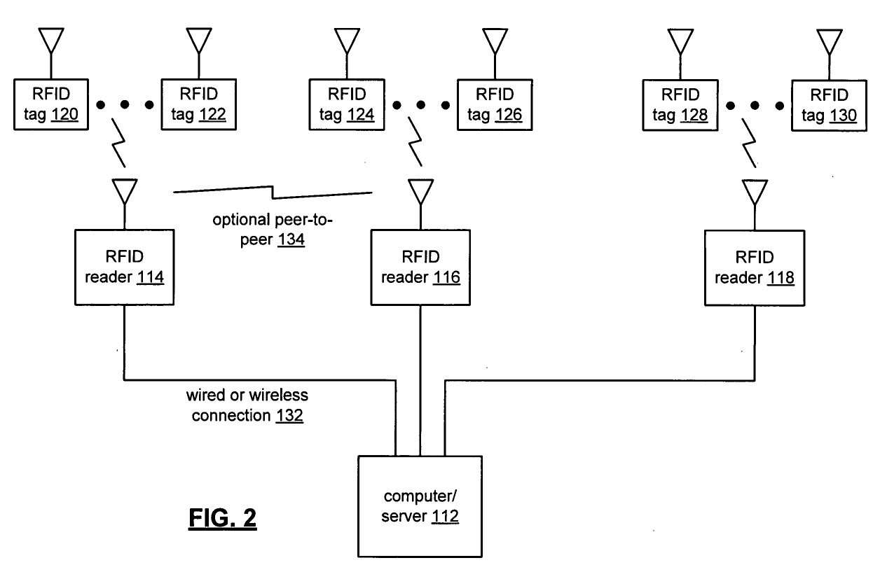

FIG. 2 is a schematic block diagram of an RFID (radio frequency identification) system that includes a computer/server 112, a plurality of RFID readers 114-118 and a plurality of RFID tags 120-130. The RFID tags 120-130 may each be associated with a particular object for a variety of purposes including, but not limited to, tracking inventory, tracking status, location determination, assembly progress, et cetera.

Each RFID reader 114-118 wirelessly communicates with one or more RFID tags 120-130 within its coverage area. For example, RFID reader 114 may have RFID tags 120 and 122 within its coverage area, while RFID reader 116 has RFID tags 124 and 126, and RFID reader 118 has RFID tags 128 and 130 within its coverage area. The RF communication scheme between the RFID readers 114-118 and RFID tags 120-130 may be a backscattering technique whereby the RFID readers 114-118 provide energy to the RFID tags via an RF signal. The RFID tags derive power from the RF signal and respond on the same RF carrier frequency with the requested data.

In this manner, the RFID readers 114-118 collect data as may be requested from the computer/server 112 from each of the RFID tags 120-130 within its coverage area. The collected data is then conveyed to computer/server 112 via the wired or wireless connection 132 and/or via the peer-to-peer communication 134. In addition, and/or in the alternative, the computer/server 112 may provide data to one or more of the RFID tags 120-130 via the associated RFID reader 114-118. Such downloaded information is application dependent and may vary greatly. Upon receiving the downloaded data, the RFID tag would store the data in a non-volatile memory.

As indicated above, the RFID readers 114-118 may optionally communicate on a peer-to-peer basis such that each RFID reader does not need a separate wired or wireless connection 132 to the computer/server 112. For example, RFID reader 114 and RFID reader 116 may communicate on a peer-to-peer basis utilizing a back scatter technique, a wireless LAN technique, and/or any other wireless communication technique. In this instance, RFID reader 116 may not include a wired or wireless connection 132 to computer/server 112. Communications between RFID reader 116 and computer/server 112 are conveyed through RFID reader 114 and the wired or wireless connection 132, which may be any one of a plurality of wired standards (e.g., Ethernet, fire wire, et cetera) and/or wireless communication standards (e.g., IEEE 802.11x, Bluetooth, et cetera).

As one of ordinary skill in the art will appreciate, the RFID system of FIG. 2 may be expanded to include a multitude of RFID readers 114-118 distributed throughout a desired location (for example, a building, office site, et cetera) where the RFID tags may be associated with equipment, inventory, personnel, et cetera. Note that the computer/server 112 may be coupled to another server and/or network connection to provide wide area network coverage.

In accordance with an embodiment of the present invention, RFID readers 114, 116 and/or 118 include a programmable antenna as will described in conjunction with FIGS. 3-16 that follow.

FIG. 3 is a schematic block diagram of a wireless transceiver, which may be incorporated in terminal such as an access point or base station 12 and 16 of FIG. 1, one or more of the wireless communication devices 18-32 of FIG. 1, one or more of the RFID readers 114-118, and/or in one or more of RFID tags 120-130. The RF transceiver 125 includes an RF transmitter 129, an RF receiver 127, a frequency control module 175 and a processing module. The RF receiver 127 includes a RF front end 140, a down conversion module 142, and a receiver processing module 144. The RF transmitter 129 includes a transmitter processing module 146, an up conversion module 148, and a radio transmitter front-end 150.

As shown, the receiver and transmitter are each coupled to a programmable antenna (171, 173), however, the receiver and transmitter may share a single antenna via a transmit/receive switch and/or diplexer. In another embodiment, the receiver and transmitter may share a diversity antenna structure that includes two or more antennas such as programmable antennas 171 and 173. In another embodiment, the receiver and transmitter may each use its own diversity antenna structure that include two or more antennas such as programmable antennas 171 and 173. In another embodiment, the receiver and transmitter may share a multiple input multiple output (MIMO) antenna structure that includes a plurality of programmable antennas (171, 173). Accordingly, the antenna structure of the wireless transceiver may depend on the particular standard(s) to which the wireless transceiver is compliant.

In operation, the RF transmitter 129 receives outbound data 162 from a host device or other source via the transmitter processing module 146. The transmitter processing module 146 processes the outbound data 162 in accordance with a particular wireless communication standard (e.g., IEEE 802.11, Bluetooth, RFID, GSM, CDMA, or other wireless telephony protocol, wireless local area network protocol, personal area network protocol, or other wireless protocol) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation 168.

The radio transmitter front end 150 includes a power amplifier 84 and may also include a transmit filter module. The power amplifier amplifies the up converted signals 166 to produce outbound RF signals 170, which may be filtered by the transmitter filter module, if included. The programmable antenna 173 transmits the outbound RF signals 170 to a targeted device such as a RF tag, and/or another wireless communication device.

The receiver receives inbound RF signals 152 via the antenna structure, where another wireless communication device transmitted the inbound RF signals 152. The programmable antenna 171 provides the inbound RF signals 152 to the receiver front-end 140. The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 includes, but is not limited to, digital intermediate frequency to baseband conversion, demodulation, demapping, depuncturing, decoding, and/or descrambling. Note that the receiver processing module 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

Frequency control module 175 controls a frequency of the transmitter local oscillation 168 and a frequency of the receiver local oscillation 158, in accordance with a desired carrier frequency. In an embodiment of the present invention, frequency control module includes a transmit local oscillator and a receive local oscillator that can operate at a plurality of selected frequencies corresponding to a plurality of carrier frequencies of the outbound RF signal 170. In addition, frequency control module 175 generates a frequency selection signal 169 that controls a selected frequency parameter of programmable antennas 171 and 173. For example, frequency selection signal 169 indicates either the current selection for the carrier frequency or the current frequency band. In operation, the carrier frequency and/or frequency band can be predetermined, selected via an application of the communications device that hosts the RF transceiver 125 or selected under user control. In alternative embodiments, the frequency control module 175 can change frequencies to implement a frequency hopping scheme that selectively controls the carrier frequency to a sequence of carrier frequencies. In a further embodiment, frequency control module 175 can evaluate a plurality of carrier frequencies and select the carrier frequency and/or frequency band based on channel characteristics such as a received signal strength indication, signal to noise ratio, signal to interference ratio, bit error rate, retransmission rate, or other performance indicator.

Processing module 275 generates a control signal 167 that operates to control the programmable antennas 171 and 173 to a selected antenna parameter or parameters such as a selected impedance, a selected bandwidth, a selected frequency response, a selected quality factor, and a selected transfer function, based on the selected frequency parameter such as the selected carrier frequency or the selected frequency band. In an embodiment of the present invention, processing module 275 includes a look-up table, algorithm or other control mechanism that selects one or more control signals 167 that operate to generate a desired value of the selected antenna parameter or parameters, based on the particular carrier frequency or frequency band or based on one or more receive characteristics such as received signal strength, signal to noise ratio, signal to noise and interference ratio, bit error rate, packet error rate, transmit power or other transceiver parameters.

In this fashion, when the RF transceiver 125 changes to a new carrier frequency or frequency band that would otherwise operate to change the gain, impedance, bandwidth, frequency response, quality factor or transfer function, programmable antenna 171 and/or 173 can be compensated by processing module 275 selecting control signals 167 to tune the programmable antenna to this new carrier frequency or frequency band to maintain desired values of one or more of these antenna parameters. Further, processing module 275 can operate to change the antenna parameters to compensate for current noise characteristics, interference or other current conditions of RF transceiver 125, based on the current selection of the carrier frequency and/or frequency band.

In an embodiment of the present invention, frequency control module 175 and processing module 275 are implemented with one or more processing modules that perform the various processing steps to implement the functions and features described herein. Such a processing module can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the control module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

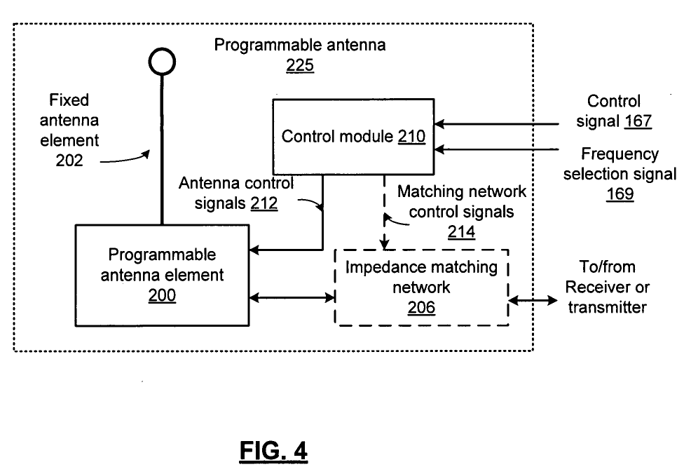

Further details regarding the programmable antennas 171 and 173 including various implementations and uses are presented in conjunction with the FIGS. 4-16 that follow.

FIG. 4 is a schematic block diagram of an embodiment of a programmable antenna in accordance with the present invention. In particular, a programmable antenna 225 is presented that includes an antenna having a fixed antenna element 202 and a programmable antenna element 200. The programmable antenna 225 further includes a control module 210 and an optional impedance matching network 206. In operation, the programmable antenna 225 is tunable to particular frequency parameter, such as a particular carrier frequency or frequency band in response to a frequency selection signal 169 and to a particular antenna parameter such as the gain, impedance, bandwidth, frequency response, quality factor or transfer function in response to a control signal 167.

The programmable antenna element 200 is coupled to the fixed antenna element 202 and is tunable in response to one or more antenna control signals 212. In this fashion, programmable antenna 225 can be dynamically tuned based on a desired antenna parameter and frequency parameter. In an embodiment of the present invention, the fixed antenna element 202 has an impedance, gain, quality factor, bandwidth, transfer function that is dependent upon the physical dimensions of the fixed antenna element, such as a length of a one-quarter wavelength antenna element or other dimension and that may be dependent upon the desired frequency or frequency band of operation.

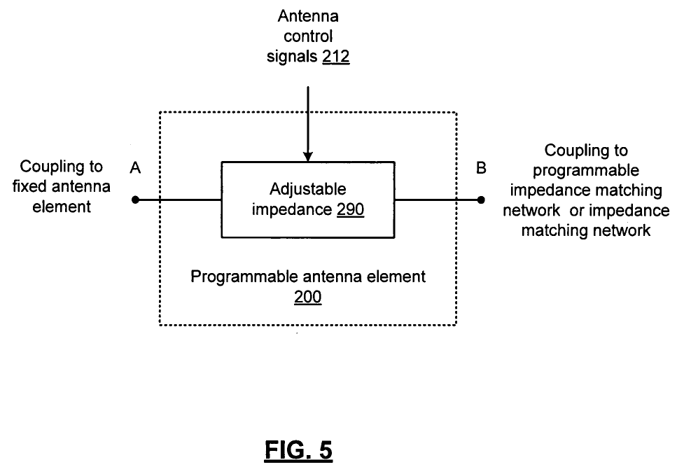

The fixed antenna element 202 can include one or more elements in combination that each can be a dipole, loop, annular slot or other slot configuration, rectangular aperture, circular aperture, line source, helical element or other element or antenna configuration. The programmable antenna element 200 can be implemented with an adjustable impedance having a reactance, and optionally a resistive component, that each can be programmed to any one of a plurality of values. Further details regarding additional implementations of programmable antenna element 200 are presented in conjunction with FIGS. 5-10 and 13 that follow.

Programmable antenna 225 optionally includes impedance matching network 206 that couples the programmable antenna 225 to and from a receiver or transmitter, either directly or through a transmission line. In an embodiment of the present invention, the impedance matching network 206 includes a transformer such as a balun transformer, an L-section, pi-network, t-network or other impedance network that performs the function of impedance matching. Impedance matching network 206 can be fixed network with fixed components. Alternatively, impedance matching network 206 can itself be adjustable based on optional matching network control signals 214 generated by control module 210 to maximize the power transfer between the antenna and the receiver or between the transmitter and the antenna, to minimize reflections and/or standing wave ratio, and/or to bridge the impedance of the antenna to the receiver and transmitter, and/or to assist programmable antenna element 200 in controlling the antenna parameter of programmable antenna 225 based on the selected frequency parameter.

Programmable antenna element 200 in conjunction with optional impedance matching network 206 can controllable modify the “effective” length or dimension of the overall antenna and/or to otherwise modifies the gain, impedance, bandwidth, quality factor and transfer function by selectively adding to or subtracting from the reactance of the programmable antenna element 200 and/or adjusting an element of optional impedance matching network 206 based on the selected frequency or frequency band. Further programmable antenna element 200 and impedance matching network 206 can conform to changes in the selected frequency of frequency band by controllably modifying the “effective” length or dimension of the overall antenna and/or adjusting an element of optional impedance matching network 206 to otherwise control the gain, impedance, bandwidth, quality factor and transfer function.

In operation, control module 210 generates the one or more antenna control signals 212 and optional matching network control signals 214 in response to a frequency selection signal 169 and control signal 167. For instance, control module 210 can produce antenna control signals 212 and optional matching network control signals 214 to adjust the programmable antenna element 200 and optional impedance matching network 206 to achieve a desired gain and bandwidth at a particular carrier frequency corresponding to a particular 802.11 channel of the 2.4 GHz band. After a change of channels or change of frequency bands indicated by frequency selection signal 169, control module 210 can produce antenna control signals 212 and optional matching network control signals 214 to adjust the programmable antenna element 200 and optional impedance matching network 206 to maintain a desired gain and bandwidth at a particular carrier frequency or band. Further, in response to increased noise or interference, low signal strength or other transmit or reception characteristics, processing module 275 can command programmable antenna 225 via control signal 167 to modify an antenna parameter such as to increase the gain, quality factor, decrease the bandwidth to adapt to these circumstances for the same frequency or frequency band.

In one mode of operation, the set of possible carrier frequencies and/or frequency bands, reflected in different frequency selection signals, are known in advance as well as the possible values of control signal 167. Control module 210 is preprogrammed with the particular antenna control signals 212 and optional matching network control signals 214 that correspond to each combination of control signal 167 and frequency selection signal 169, so that logic or other circuitry, or programming such as via a look-up table can be used to retrieve the particular antenna control signals 212 and optional matching network control signals 214. In a further mode of operation, the control module 210, generates antenna control commands 212 and optional matching network control signals 214 directly based on the values of frequency selection signal 169 and control signal 167.

In an embodiment of the present invention, control module 210 includes a processing module that performs various processing steps to implement the functions and features described herein. Such a processing module can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the control module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. While shown as a separate device, the function of control module 210 can be merged with those of either frequency selection module 175 and/or processing module 275.

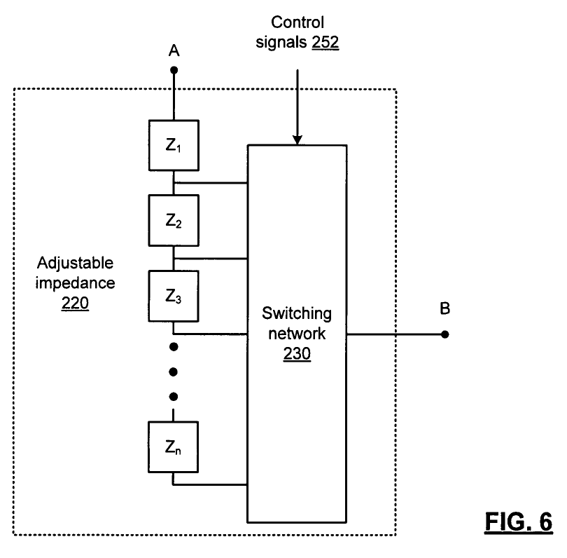

FIG. 5 is a schematic block diagram of an embodiment of a programmable antenna element in accordance with the present invention. In particular, programmable antenna element 200 is shown that includes an adjustable impedance 290 that is adjustable in response to antenna control signal 212. Adjustable impedance 290 is a complex impedance with an adjustable reactance and optionally a resistive component that is also adjustable. Adjustable impedance can include at least one adjustable reactive element such as an adjustable inductor, an adjustable capacitor, an adjustable tank circuit, an adjustable transformer such as a balun transformer or other adjustable impedance network or network element. Several additional implementations of adjustable impedance 290 are presented in conjunction with FIGS. 6-10 and 13 that follow.

FIG. 6 is a schematic block diagram of an embodiment of an adjustable impedance in accordance with the present invention. An adjustable impedance 220 is shown that includes a plurality of fixed network elements Z₁, Z₂, Z₃, . . . Zₙ such as resistors, or reactive network elements such as capacitors, and/or inductors. A switching network 230 selectively couples the plurality of fixed network elements in response to one or more control signals 252, such as antenna control signals 212. In operation, the switching network 230 selects at least one of the plurality of fixed reactive network elements and that deselects the remaining ones of the plurality of fixed reactive network elements in response to the control signals 252. In particular, switching network 230 operates to couple one of the plurality of taps to terminal B. In this fashion, the impedance between terminals A and B is adjustable to include a total impedance Z₁, Z₁+Z₂, Z₁+Z₂+Z₃, etc, based on the tap selected. Choosing the fixed network elements Z₁, Z₂, Z₃, . . . Zₙ to be a plurality of inductors, allows the adjustable impedance 220 to implement an adjustable inductor having a range from (Z₁ to Z₁+Z₂+Z₃+ . . . +Zₙ). Similarly, choosing the fixed network elements Z₁, Z₂, Z₃, . . . Zₙ to be a plurality of capacitors, allows the adjustable impedance 220 to implement an adjustable capacitor, etc.

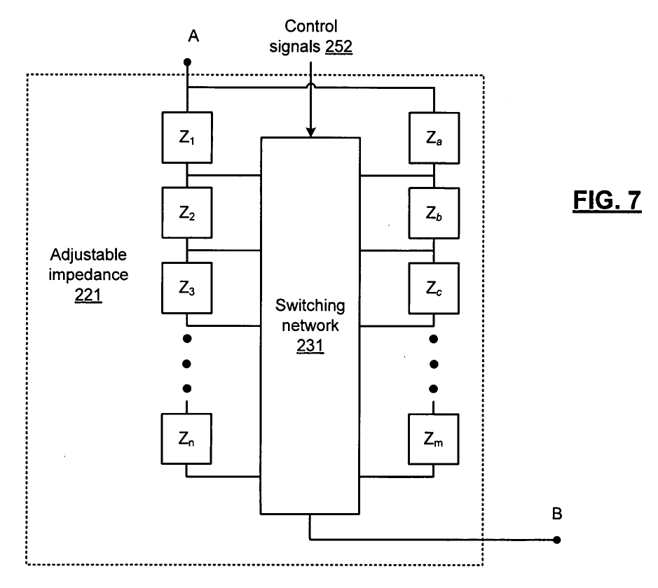

FIG. 7 is a schematic block diagram of an embodiment of an adjustable impedance in accordance with the present invention. An adjustable impedance 221 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 231 selectively couples the plurality of fixed network elements in response to one or more control signals 252, such as antenna control signals 212 to form a parallel combination of two adjustable impedances. In operation, the switching network 231 selects at least one of the plurality of fixed reactive network elements and that deselects the remaining ones of the plurality of fixed reactive network elements in response to the control signals 252. In particular, switching network 231 operates to couple one of the plurality of taps from the group A impedances to one of the plurality of taps of the group B impedances to the terminal B. In this fashion, the impedance between terminals A and B is adjustable and can be to form a parallel circuit such as parallel tank circuit having a total impedance equal to the parallel combination between a group A impedance Z_{A}=Z₁, Z₁+Z₂, or Z₁+Z₂+Z₃, etc, and a Group B impedance Z_{B}=Zₐ, Zₐ+Z_{b}, or Zₐ+Z_{b}+Z_{c}, etc., based on the taps selected.

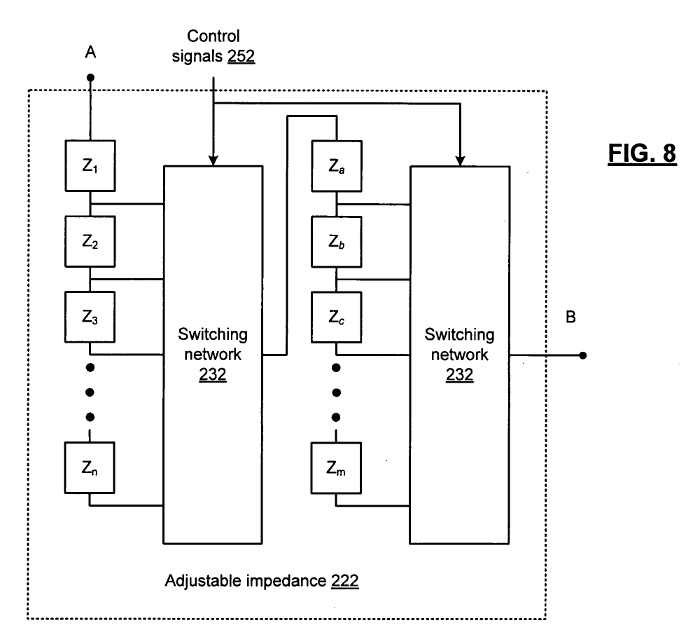

FIG. 8 is a schematic block diagram of an embodiment of an adjustable impedance in accordance with the present invention. An adjustable impedance 222 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 232 selectively couples the plurality of fixed network elements in response to one or more control signals 252, such as antenna control signals 212 to form a series combination of two adjustable impedances. In operation, the switching network 232 selects at least one of the plurality of fixed reactive network elements and that deselects the remaining ones of the plurality of fixed reactive network elements in response to the control signals 252. In particular, switching network 232 operates to couple one of the plurality of taps from the group A impedances to the group B impedances and one of the plurality of taps of the group B impedances to the terminal B. In this fashion, the impedance between terminals A and B is adjustable and can be to form a series circuit such as series tank circuit having a total impedance equal to the series combination between a group A impedance Z_{A}=Z₁, Z₁+Z₂, or Z₁+Z₂+Z₃, etc, and a Group B impedance Z_{B}=Zₐ, Zₐ+Z_{b}, or Zₐ+Z_{b}+Z_{c}, etc., based on the taps selected.

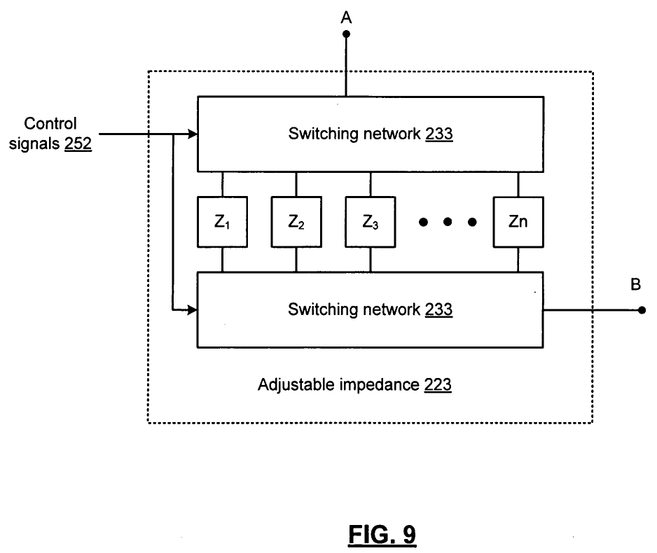

FIG. 9 is a schematic block diagram of an embodiment of an adjustable impedance in accordance with the present invention. An adjustable impedance 223 is shown that includes a plurality of fixed network elements Z₁, Z₂, Z₃, . . . Zₙ such as resistors, or reactive network elements such as capacitors, and/or inductors. A switching network 233 selectively couples the plurality of fixed network elements in response to one or more control signals 252, such as antenna control signals 212. In operation, the switching network 233 selects at least one of the plurality of fixed reactive network elements and that deselects the remaining ones of the plurality of fixed reactive network elements in response to the control signals 252. In particular, switching network 233 operates to couple one of the plurality of taps of the top legs of the selected elements to terminal A and the corresponding bottom legs of the selected elements to terminal B. In this fashion, the impedance between terminals A and B is adjustable to include a total impedance that is the parallel combination of the selected fixed impedances. Choosing the fixed network elements Z₁, Z₂, Z₃, . . . Zₙ to be a plurality of inductances, allows the adjustable impedance 220 to implement an adjustable inductor, from the range from the parallel combination of (Z₁, Z₂, Z₃, . . . Zₙ) to MAX(Z₁, Z₂, Z₃. . . . Zₙ). Also, the fixed network elements Z₁, Z₂, Z₃, Zₙ can be chosen as a plurality of capacitances.

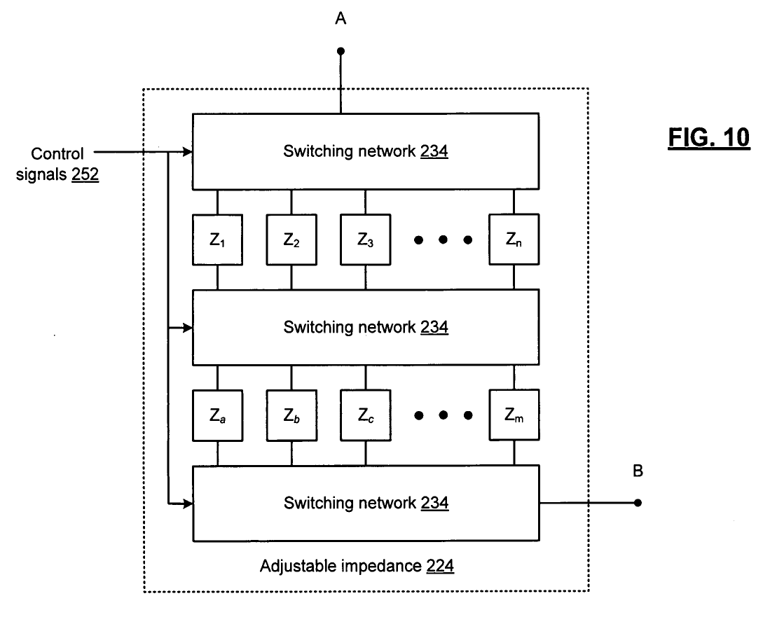

FIG. 10 is a schematic block diagram of an embodiment of an adjustable impedance in accordance with the present invention. An adjustable impedance 224 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 234 selectively couples the plurality of fixed network elements in response to one or more control signals 252, such as antenna control signals 212 to form a series combination of two adjustable impedances. In operation, the switching network 234 selects at least one of the plurality of fixed reactive network elements and that deselects the remaining ones of the plurality of fixed reactive network elements in response to the control signals 252. In particular, switching network 232 operates to couple a selected parallel combination of impedances from the group A in series with a selected parallel combination of group B impedances. In this fashion, the impedance between terminals A and B is adjustable and can be to form a series circuit such as series tank circuit having a total impedance equal to the series combination between a group A impedance Z_{A} and a Group B impedance Z_{B}, based on the taps selected.

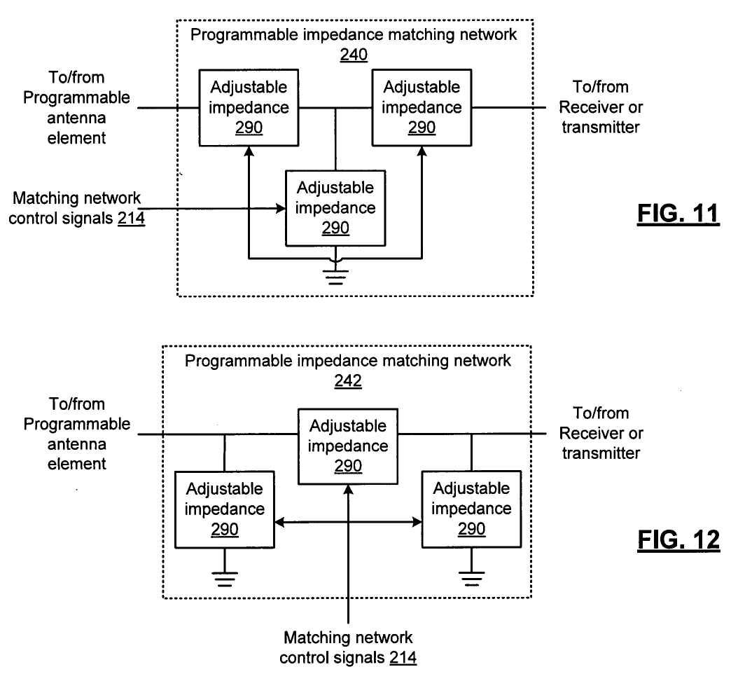

FIG. 11 is a schematic block diagram of an embodiment of a programmable impedance matching network in accordance with the present invention. A programmable impedance matching network 240 is shown that includes a plurality of adjustable impedances 290, responsive to matching control signals 214. In particular, each of the adjustable impedances 290 can be implemented in accordance with any of the adjustable impedances discussed in association with the impedances used to implement programmable antenna element 200 discussed in FIGS. 6-10, with the control signals 252 being supplied by matching network control signal 214, instead of antenna control signals 212. In the configuration shown, a t-network configuration is implemented with three adjustable impedances, however, one or more these adjustable impedances can alternatively be replaced by an open-circuit or short circuit to produce other configurations including an L-section matching network. Further, one or more of the adjustable impedances 290 can be replaced by fixed impedances, such as resistors, or fixed reactive network elements.

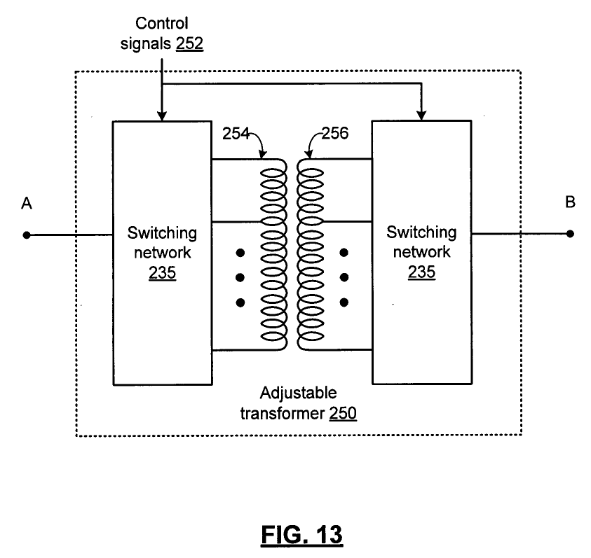

FIG. 12 is a schematic block diagram of an embodiment of a programmable impedance matching network in accordance with the present invention. A programmable impedance matching network 242 is shown that includes a plurality of adjustable impedances 290, responsive to matching control signals 214. In particular, each of the adjustable impedances 290 can be implemented in accordance with any of the adjustable impedances discussed in association with the impedances used to implement programmable antenna element 200 discussed in FIGS. 6-10, with the control signals 252 being supplied by matching network control signal 214, instead of antenna control signals 212. In the configuration shown, a pi-network configuration is implemented with three adjustable impedances, however, one or more these adjustable impedances can alternatively be replaced by an open-circuit or short circuit to produce other configurations. Further, one or more of the adjustable impedances 290 can be replaced by fixed impedances, such as resistors, or fixed reactive network elements.

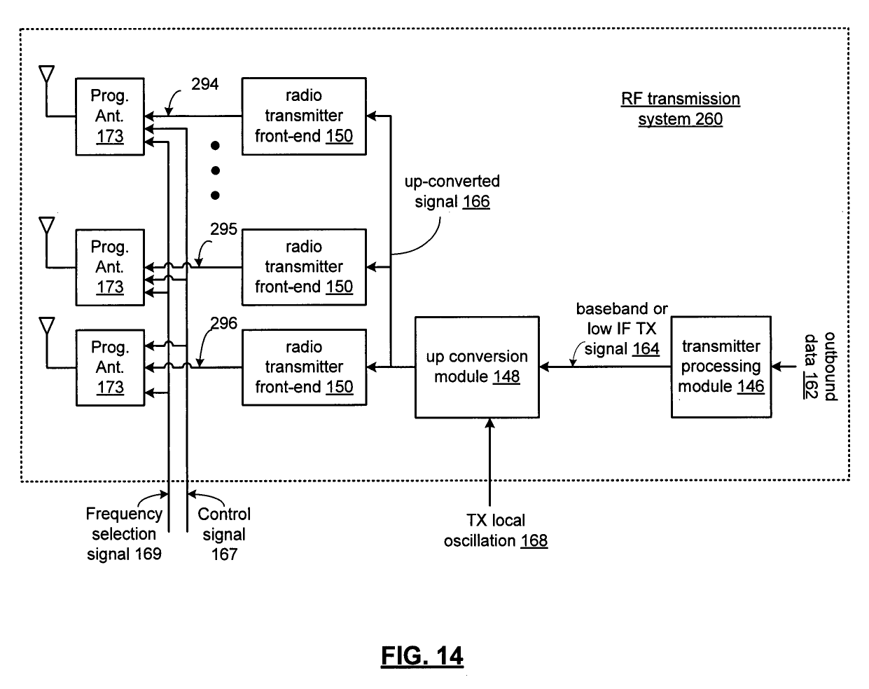

FIG. 13 is a schematic block diagram of an embodiment of an adjustable transformer in accordance with the present invention. An adjustable transformer is shown that can be used in either the implementation of programmable antenna element 200, with control signals 252 being supplied by antenna control signals 212. Alternatively, adjustable transformer 250 can be used to implement all or part of the programmable impedance matching network 204, with control signals 252 being supplied by matching network control signals 214. In particular, multi-tap inductors 254 and 256 are magnetically coupled. Switching network 235 controls the tap selection for terminals A and B (and optionally to ground) to produce a transformer, such as a balun transformer or other voltage/current/impedance transforming device with controlled impedance matching characteristics and optionally with controlled bridging.

FIG. 14 is a schematic block diagram of an RF transmission system in accordance with the present invention. An RF transmission system 260 is disclosed that includes many common elements from RF transmitter 129 that are referred to by common reference numerals. In particular, RF transmission system 260 includes either a plurality of RF transmitters or a plurality of RF transmitter front ends 150 that generate a plurality of RF signals 294-296 at a selected carrier frequency or frequency band in response to a frequency selection signal 169. A plurality of programmable antennas 173 such as antennas 225, are adjusted in response to the frequency selection signal 169 and control signal 167, to transmit a corresponding one of the plurality of RF signals 294-296.

In an embodiment of the present invention, the plurality of RF transmitter front ends 150 are implemented as part of a multi-input multi-output (MIMO) transceiving system that broadcasts multiple signals that are recombined in the receiver. In one mode of operation, antennas 173 can be spaced with physical diversity. In an embodiment of the present invention, the plurality of RF transmitter front-ends are implemented as part of a polarization diversity transceiving system that broadcasts multiple signals at different polarizations by antennas 173 configured at a plurality of different polarizations.

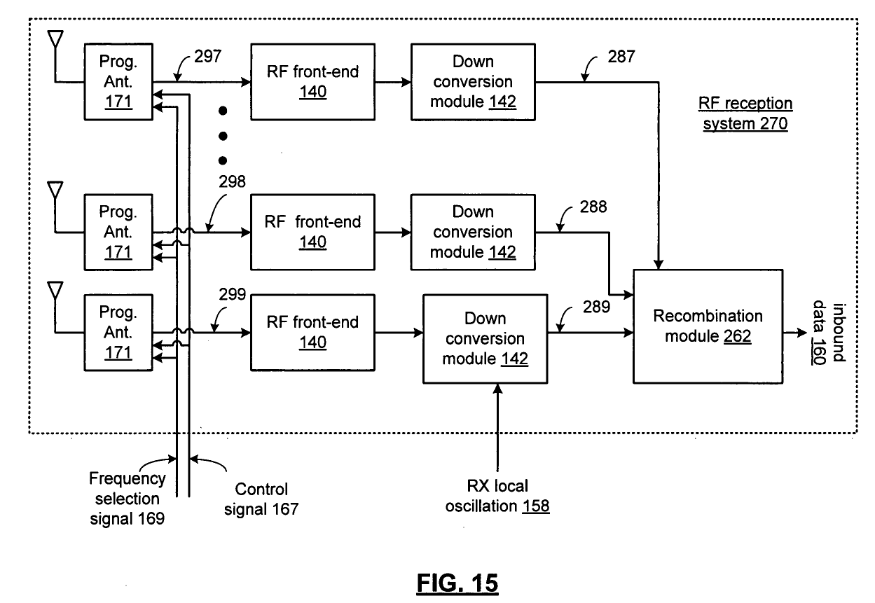

FIG. 15 is a schematic block diagram of an RF reception system in accordance with the present invention. An RF reception system 260 is disclosed that includes many common elements from RF receiver 127 that are referred to by common reference numerals. In particular, a plurality of programmable antennas 171 are adjusted in response to a frequency selection signal 169 and the control signal 167. The plurality of programmable antennas receive RF signals 297-299 having the selected carrier frequency. A plurality of RF receivers include RF front-ends 140 and down conversion modules 142, to demodulate the RF signal 297-299 into demodulated signal 287-289. A recombination module 262 produces a recombined data signal, such as inbound data 160 from the demodulated signals 287-289.

In an embodiment of the present invention, the plurality of RF front ends 140 are implemented as part of a multi-input multi-output (MIMO) transceiving system that broadcasts multiple signals that are recombined in the receiver. In one mode of operation, antennas 171 can be spaced with physical diversity. In an embodiment of the present invention, the plurality of RF front-ends 140 are implemented as part of a polarization diversity transceiving system that broadcasts multiple signals at different polarizations that are received by antennas 171, which are configured at a plurality of different polarizations.

Recombination module 262 can include a processing module that performs various processing steps to implement the functions and features described herein. Such a processing module can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

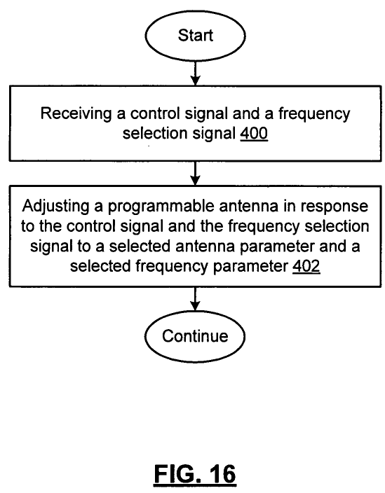

FIG. 16 is a flowchart representation of a method in accordance with an embodiment of the present invention. In particular a method is presented for use with one or more features or functions presented in conjunction with FIGS. 1-15. In step 400, a frequency selection signal and control signal are received. In step 402, a programmable antenna is adjusted in response to the control signal and the frequency selection signal to a selected antenna parameter and a selected frequency parameter.

In an embodiment of the present invention, the selected antenna parameter includes at least one of, a selected impedance, a selected bandwidth, a selected frequency response, a selected quality factor, and a selected transfer function. The selected frequency parameter can include at least one of, a selected frequency, and a selected frequency band.

In an embodiment of the present invention step 402 includes generating at least one matching network signal based on the control signal and the frequency selection signal, and tuning a programmable impedance matching network in response to the at least one matching network control signal. Step 402 can also include generating at least one antenna control signal based on the control signal and the frequency selection signal, and tuning a programmable antenna element in response to the at least one antenna control signal.

The terminal device can includes at least one of, a base station, a mini base station, an RFID reader and an access point. The terminal device can operate in accordance with at least one of, a wireless local area network protocol, and a personal area network protocol. The terminal device can include a multi-input multi-output transceiver.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A terminal device comprising:
a transceiver;
a programmable antenna, coupled to the transceiver, that is adjustable in response to a control signal and a frequency selection signal to a selected antenna parameter and a selected frequency parameter, wherein the selected antenna parameter includes at least one of, a selected impedance, a selected bandwidth, a selected frequency response, a selected quality factor, and a selected transfer function, and wherein the selected frequency parameter includes at least one of, a selected frequency, and a selected frequency band.

2. The terminal device of claim 1 wherein the programmable antenna includes:
a fixed antenna element;
a programmable antenna element, coupled to the fixed antenna element, that is tunable in response to at least one antenna control signal;
a programmable impedance matching network, coupled to the programmable antenna element, that includes a plurality of adjustable reactive network elements that are tunable in response in response to a corresponding plurality of matching network control signals; and
a control module, coupled to the programmable antenna element and the programmable impedance matching network, that generates the at least one antenna control signal and the plurality of matching network control signals, in response to a frequency selection signal and the control signal.

3. The terminal device of claim 1 wherein the terminal device includes at least one of, a base station, a mini base station, an RFID reader and an access point.

4. The terminal device of claim 1 wherein the transceiver operates in accordance with at least one of, a wireless local area network protocol, and a personal area network protocol.

5. The terminal device of claim 1 wherein the transceiver includes a multi-input multi-output transceiver and wherein the terminal device comprises:
at least one additional programmable antenna, coupled to the transceiver, that is adjustable in response to the control signal and the frequency selection.

6. A terminal device comprising:
a transceiver;
a programmable antenna, coupled to the transceiver, that is adjustable in response to a control signal and a frequency selection signal to a selected antenna parameter and a selected frequency parameter.

7. The terminal device of claim 6 wherein the selected antenna parameter includes at least one of, a selected impedance, a selected bandwidth, a selected frequency response, a selected quality factor, and a selected transfer function.

8. The terminal device of claim 6 wherein the selected frequency parameter includes at least one of, a selected frequency, and a selected frequency band.

9. The terminal device of claim 6 wherein the programmable antenna includes:
a fixed antenna element;
a programmable antenna element, coupled to the fixed antenna element, that is tunable in response to at least one antenna control signal;
a programmable impedance matching network, coupled to the programmable antenna element, that includes a plurality of adjustable reactive network elements that are tunable in response in response to a corresponding plurality of matching network control signals; and
a control module, coupled to the programmable antenna element and the programmable impedance matching network, that generates the at least one antenna control signal and the plurality of matching network control signals, in response to a frequency selection signal and the control signal.

10. The terminal device of claim 6 wherein the terminal device includes at least one of, a base station, a mini base station, an RFID reader and an access point.

11. The terminal device of claim 6 wherein the transceiver operates in accordance with at least one of, a wireless local area network protocol, and a personal area network protocol.

12. The terminal device of claim 6 wherein the transceiver includes a multi-input multi-output transceiver and wherein the terminal device comprises:
at least one additional programmable antenna, coupled to the transceiver, that is adjustable in response to the control signal and the frequency selection.

13. A method for use in a terminal device, the method comprising:
receiving a control signal and a frequency selection signal;
adjusting a programmable antenna in response to the control signal and the frequency selection signal to a selected antenna parameter and a selected frequency parameter.

14. The method of claim 13 wherein the selected antenna parameter includes at least one of, a selected impedance, a selected bandwidth, a selected frequency response, a selected quality factor, and a selected transfer function.

15. The method of claim 13 wherein the selected frequency parameter includes at least one of, a selected frequency, and a selected frequency band.

16. The method of claim 13 wherein adjusting the programmable antenna includes:
generating at least one matching network signal based on the control signal and the frequency selection signal; and
tuning a programmable impedance matching network in response to the at least one matching network control signal.

17. The method of claim 13 wherein adjusting the programmable antenna includes:
generating at least one antenna control signal based on the control signal and the frequency selection signal; and
tuning a programmable antenna element in response to the at least one antenna control signal.

18. The method of claim 13 wherein the terminal device includes at least one of, a base station, a mini base station, an RFID reader and an access point.

19. The method of claim 13 wherein the terminal device operates in accordance with at least one of, a wireless local area network protocol, and a personal area network protocol.

20. The method of claim 13 wherein the terminal device includes a multi-input multi-output transceiver.
